(19) United States
(12) Patent Application Publication
(10) Pub. No.: US 2008/0101166 A1
(43) Pub. Date: May 1, 2008

(54) Optical element and optical pickup apparatus

(75) Inventor: Kiyono Ikenaka, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 11/975,544

(22) Filed: Oct. 19, 2007

(30) Foreign Application Priority Data
Oct. 27, 2006 (JP) JP2006-292606

(51) Int. Cl. G11B 11/00; G11B 7/00

(52) U.S. Cl. 369/13.53; 369/112.12; 369/121

(57) ABSTRACT

The present invention provides an optical element for use in an optical pickup apparatus. The optical element includes: a first lens section and a second lens section formed in one body. The first lens section includes an optical surface divided by a border defined by a first predetermined diameter into a first inner area and a first outer area. The surface-normal angle of the first inner area at an outer edge thereof is larger than that of the first outer area at an inner edge thereof. The second lens section includes an optical surface divided by a border defined by a second predetermined diameter into a second inner area and a second outer area. The surface-normal angle of the second inner area at an outer edge thereof is smaller than that of the second outer area at an inner edge thereof.

This application is based on Japanese Patent Application No. 2006-292606 filed on Oct. 27, 2006, in Japanese Patent Office, the entire content of which is hereby incorporated by reference.

### TECHNICAL FIELD

The present invention relates to an optical element for an optical pickup apparatus capable of conducting recording and/or reproducing of information for optical information recording media (which are also called optical discs) each being different in terms of a kind, and to an optical pickup apparatus employing the aforesaid optical element.

### BACKGROUND

In recent years, studies and developments have been advanced rapidly for high density optical discs capable of conducting recording and/or reproducing of information (hereinafter, “recording and/or reproducing” will be described as “recording/reproducing”) by using a violet semiconductor laser having a wavelength of about 400 nm. As an example, in the case of an optical disc conducting information recording/reproducing at specifications of NA 0.65 and a light source wavelength of 405 nm, namely, in the case of the so-called HD DVD (hereinafter referred to as HD), it is possible to record information of 15-20 GB per one layer, for an optical disc with a diameter of 12 cm. From now on, the optical disc of this kind is called “a high density disc” in the present specification. In the case of the optical pickup apparatus capable of conducting recording/reproducing of information for HD, an objective lens made of glass is sometimes used for obtaining excellent optical characteristics.

With a background of reality that DVD and CD (compact disc) on which various types of information are recorded are on the market, it is desired that a single player can conduct recording/reproducing of information properly for optical discs of various types as far as possible. Further, when considering actual circumstances that an optical pickup apparatus is often mounted on a notebook computer, only interchangeability for plural types of optical discs is not enough, and realization of downsizing of them is important.

If different optical discs can be used in an optical pickup apparatus compatibly by employing a single objective lens, it is preferable for realizing downsizing. However, when considering specifications of a high density optical disc, it is technically difficult to make objective lenses to be common. For example, BD and HD are different in terms of a protective substrate thickness, and they use a light flux with the same wavelength, therefore, aberration of the objective lens is hardly corrected by using a diffractive structure, resulting in actual circumstances that realizing a compatible objective lens is difficult.

A compatible lens for DVD/CD has already been put to practical use for downsizing. However, WD (working distance) for CD needs to be secured to a certain extent, thus, an effective aperture for DVD is greater than that of CD, and an outside diameter of the compatible lens tends to be greater. In contrast to this, if an exclusive lens for each of DVD and CD is used, WD on the CD side is free from the restriction, and a lens for DVD can be made small.

For obtaining more preferable optical capability through “compatibility” and “downsizing” of an objective lens in the compatible optical pickup apparatus, the use of composite optical element wherein lenses are arranged in parallel and be formed in one body is considered. Compared with an occasion to use two lenses formed separately, the composite optical element of this kind has a merit that a distance between lenses can be narrowed, because their flange portions can be made common. There is further a merit that assembling and adjusting can be simplified and cost reduction can be achieved. An example of the composite optical element of this kind is described in Japanese Patent Publication Open to Public Inspection (JP-A) No. 9-115170.

### SUMMARY

Now, even when the composite optical element described in JP-A No. 9-115170 is used, there still is a demand to make an optical pickup apparatus to be more compact. This is a first purpose. To make an optical pickup apparatus more compact, it is preferable to make two lenses to be equal in terms of an effective aperture, because a size of the optical pickup apparatus is influenced by the sum of WD, a paraxial thickness of a lens and effective apertures. Further, for positional adjustment of an objective lens by an actuator, it is preferable that WD of each lens is also close to the same length.

However, if the foregoing is satisfied, a thickness of a flange becomes different from others, which is a problem. With respect to the composite optical element, however, it is considered to be preferable that a thickness of a flange portion between lenses is made to be the same, and both surfaces arranged in a direction perpendicular to the optical axis are made to be in parallel without any steps. This is a second purpose.

Further, when providing a diaphragm in the optical pickup apparatus, there is a problem that it is difficult to adjust so that a position of the diaphragm may agree with that of each lens portion, if a plurality of lens portions are formed integrally in one body. This is a third purpose.

After making an earnest effort of studies in view of the aforesaid problems of a conventional technology, the inventor of the present invention has come to realize an optical element of the invention that can achieve the aforesaid first, second and third purposes together entirely. Namely, one of objectives is to provide an optical element for the optical pickup apparatus so as to provide effective apertures set to equal and WDs close to the same length, to allow the optical pickup apparatus to be more compact, to be more easily molded by making flange thicknesses to be uniform, and to simplify the structure of the optical pickup apparatus without providing a separate diaphragm on the pickup apparatus. Further, providing an optical element having excellent effects by applying the same conception to a coupling lens such as a collimator lens is also one of objects of the invention.

An optical element relating to the present invention is provided for use in an optical pickup apparatus which comprises a single or a plurality of light source, and an optical element. The optical element comprises: a first objective lens section and a second objective lens section formed in one body. The optical pickup apparatus is adopted to record and/or reproduce information on an information recording surface of a first optical information recording medium by converging a light flux from the light source through the first objective lens section onto the information recording surface, and to record and/or reproduce information on an information recording surface of a second optical information recording medium by converging a light flux from the light source through the second objective lens section onto the information recording surface. The first objective lens section comprises an optical surface divided by a border defined by a first predetermined diameter into a first inner area and a first outer area. The first inner area is arranged on an inside of the border in a direction perpendicular to an optical axis and has a surface-normal angle θi1 at an outer edge thereof. The first outer area is arranged on an outside of the border in the direction perpendicular to the optical axis and has a surface-normal angle θo1 at an inner edge thereof. Where, the angle θi1 is larger than the angle θo1. The second objective lens section comprises an optical surface divided by a border defined by a second predetermined diameter into a second inner area and a second outer area. The second inner area is arranged on an inside of the border in a direction perpendicular to an optical axis and has a surface-normal angle θi2 at an outer edge thereof. The second outer area arranged on an outside of the border in the direction perpendicular to the optical axis and has a surface-normal angle θo2 of at an inner edge thereof. Where, the angle θi2 is smaller than the angle θo2. Further, the optical element satisfies the following condition according to the first objective lens section and the second objective lens section.
L1>L2
L1 is a distance along the optical axis from a peak of the optical surface of the first objective lens section to the border defined by the first predetermined diameter. L2 is a distance along the optical axis from a peak of the optical surface of the second objective lens section to the border defined by the second predetermined diameter.

These and other objects, features and advantages according to the present invention will become more apparent upon reading of the following detailed description along with the accompanied drawings.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a side view showing an example of optical element OE relating to the invention;

FIG. 2 is a sectional view in the direction perpendicular to the optical axis direction of the optical element OE shown in FIG. 1;

FIG. 3(a) is an example of a longitudinal spherical aberration diagram for a light flux that has passed through the first objective lens OL1 in the case of using the first optical information recording medium, and FIG. 3(b) is an example of a longitudinal spherical aberration diagram for a light flux that has passed through the second objective lens OL2 in the case of using the second optical information recording medium;

FIG. 4 is a diagram showing schematically the structure of first optical pickup apparatus PU1;

FIG. 5 is a diagram for illustrating L1 and L2;

FIG. 6 is a diagram showing schematically the structure of second optical pickup apparatus PU2;

Each of FIG. 7(a) and FIG. 7(b) is a longitudinal spherical aberration diagram relating to Example 1;

Each of FIG. 8(a) and FIG. 8(b) is a longitudinal spherical aberration diagram relating to Example 2;

Each of FIG. 9(a) and FIG. 9(b) is a longitudinal spherical aberration diagram relating to Example 3;

FIG. 10 is a perspective view of optical element OE;

FIG. 11 is a diagram showing schematically the structure of third optical pickup apparatus PU3; and

FIG. 12 is a diagram showing schematically the structure of fourth optical pickup apparatus PU4.

### DESCRIPTION OF THE PREFERRED EMBODIMENT

A preferable embodiment of the invention will be explained as follows.

In the present specification, an optical disc (which is also called optical information recording medium) employing a violet semiconductor laser or a violet SHG laser as a light source for recording/reproducing of information is called generically “a high density optical disc”, and it is assumed that an optical disc (for example, HD DVD: that is called HD simply) that conducts recording/reproducing of information with an objective optical system having NA of 0.65-0.67, and has a standard of a protective substrate thickness of about 0.6 mm is also included, in addition to an optical disc (for example, BD: Blu-ray disc) that conducts recording/reproducing of information with an objective optical system having NA of 0.85, and has a standard of a protective substrate thickness of about 0.1 mm. Further, in addition to the optical disc having the protective substrate of this kind on an information recording surface, an optical disc having a protective substrate thickness of about several nanometers—several tens nanometers on an information recording surface and an optical disc where a protective substrate or a thickness of the protective substrate is 0 are assumed to be included. Further, in the present specification, a magnet-optical disc employing a violet semiconductor laser or a violet SHG laser as a light source for conducting recording/reproducing of information is also assumed to be included in a high density optical disc.

In addition, in the present specification, DVD is a generic name for a DVD-based optical disc such as DVD-ROM, DVD-Video, DVD-Audio, DVD-RAM, DVD-R, DVD-RW, DVD+R and DVD+RW, while, CD is a generic name for a CD-based optical disc such as CD-ROM, CD-Audio, CD-Video, CD-R and CD-RW. Recording density is highest for a high density optical disc, and it is lowered one after another in the order of DVD and CD.

A first embodiment according to the present invention is an optical element for use in an optical pickup apparatus which comprises a single or a plurality of light source, and an optical element. The optical element comprises: a first objective lens section and a second objective lens section formed in one body. The first objective lens section comprises an optical surface divided by a border defined by a first predetermined diameter into a first inner area and a first outer area. The first inner area is arranged on an inside of the border in a direction perpendicular to an optical axis and has a surface-normal angle θi1 at an outer edge thereof. The first outer area is arranged on an outside of the border in the direction perpendicular to the optical axis and has a surface-normal angle θo1 at an inner edge thereof. Where, the angle θi1 is larger than the angle θo1. The second objective lens section comprises an optical surface divided by a border defined by a second predetermined diameter into a second inner area and a second outer area. The second inner area is arranged on an inside of the border in a direction perpendicular to an optical axis and has an angle θi2 of a surface normal at an outer edge thereof. The second outer area is arranged on an outside of the border in the direction perpendicular to the optical axis and has a surface-normal angle θo2 of at an inner edge thereof. Where, the angle θi2 is smaller than the angle θo2. The optical pickup apparatus is adopted to record and/or reproduce information on an information recording surface of a first optical information recording medium by conversing a light flux from the light source through the first objective lens section onto the information recording surface, and to record and/or reproduce information on an information recording surface of a second optical information recording medium by conversing a light flux from the light source through the second objective lens section onto the information recording surface. The optical element satisfies the following expression:
L1>L2, (1)
where L1 is a distance along the optical axis from a peak of the optical surface of the first objective lens section to the border defined by the first predetermined diameter, and L2 is a distance along the optical axis from a peak of the optical surface of the second objective lens section to the border defined by the second predetermined diameter.

The principle of embodiment of the invention will be explained as follows.

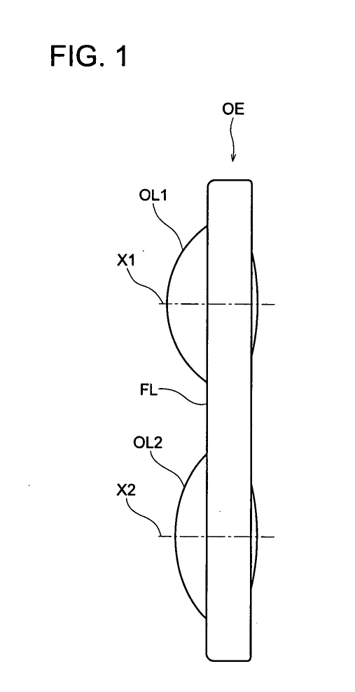

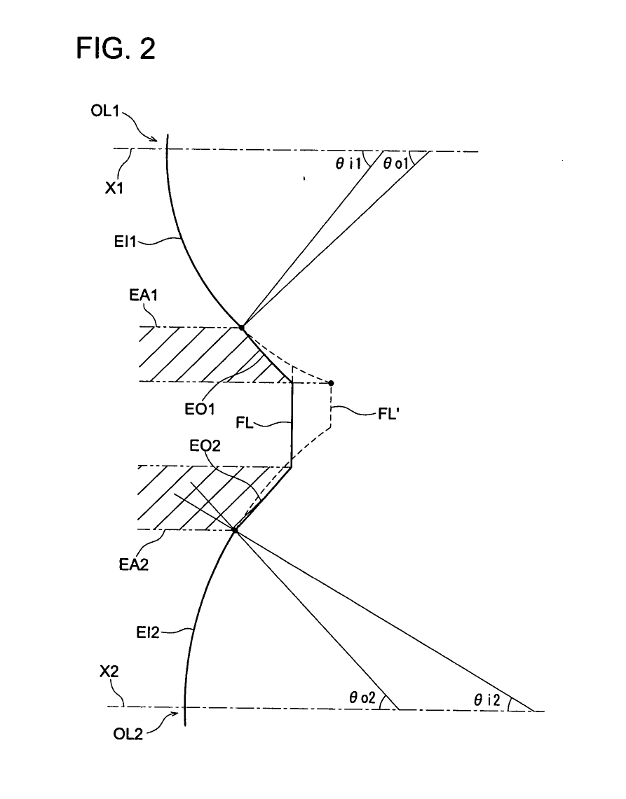

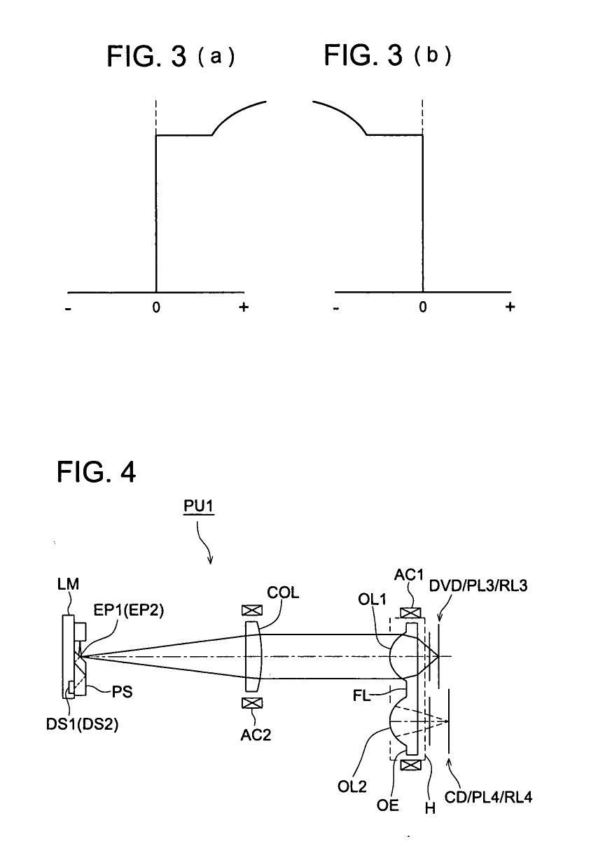

FIG. 1 is a side view showing an example of optical element OE relating to the present invention. FIG. 2 is a sectional view in the direction perpendicular to the optical axis direction of the optical element OE shown in FIG. 1. The principle of the embodiment will be shown, referring to the drawings. FIG. 3(a) is an example of a longitudinal spherical aberration diagram for a light flux that has passed through the first objective lens OL1 in the case of using the first optical information recording medium, and FIG. 3(b) is an example of a longitudinal spherical aberration diagram for a light flux that has passed through the second objective lens OL2 in the case of using the second optical information recording medium. With respect to a sign, a −(minus) side is an objective side. Incidentally, the invention is not limited to the following explanation.

In FIG. 1, optical element OE is composed of first objective lens section OL1 whose center is arranged on first optical axis X1, second objective lens section OL2 whose center is arranged on second optical axis X2 that is in parallel with the first optical axis X1, and of flange section FL that is formed around the first objective lens section OL1 and the second objective lens section OL2, which are integrally formed in one body. It is preferable that the flange section FL is extending in the direction perpendicular to the first optical axis X1 and the second optical axis X2.

On the optical surface of the first objective lens section OL1 in FIG. 2, defining a border by an effective diameter EA1, EI1 represents a first inner-effective diameter-area which is an area on the optical axis X1 side (namely, the inside) of the effective diameter EA1, and EO1 represents a first outer-effective diameter area which is an area outside the effective diameter EA1. Further, on the optical surface of the second objective lens section OL2, defining a border by an effective diameter EA2, EI2 represents a second inner-effective diameter area that is an area on the optical axis X2 side (namely, the inside) of the effective diameter EA2, and EO2 represents a second outer-effective diameter area that is an area outside the effective diameter EA2. Incidentally, first inner-effective diameter area EI1 and first outer-effective diameter area EO1 may also be provided on the light source side, or on the optical information recording medium side. Further, second inner-effective diameter area EI2 and second outer-effective diameter area EO2 may also be provided on the light source side, or on the optical information recording medium side. In embodiments of the invention, it is possible to exhibit an effect by defining a border from a predetermined diameter and by dividing an optical surface into an inner area and an outer area by the border. However, for obtaining more remarkable effects, it is preferable that the effective diameter is made to be a border. In the meantime, “effective diameter” is assumed to mean a diameter of an area on the optical surface through which a light flux used for recording/reproducing for an optical information recording medium passes. Further, a description that a surface-normal angle changes at a border defined by the effective diameter in the present specification is regarded to mean that a surface-normal angle changes at a border satisfying 0.95 W or more and 1.05 W or less, where W represents an effective diameter of a lens section.

Now, the first inner-effective-diameter area EI1 has a shape so that a light flux having passed through the first inner-effective-diameter area EI1 forms a light-converged spot on an information recording surface of the first optical information recording medium (not shown) under the condition that the aberration is corrected. On the other hand, the first outer-effective-diameter EO1 has a shape of refractive surface so that a light flux having passed through the first outer-effective-aperture area EO1 forms a flare light on an information recording surface of the first optical information recording medium (not shown), thus, the first outer-effective-diameter area generates over-corrected aberration on the outside of an effective diameter as shown in FIG. 3(a). This feature provides a function of a diaphragm.

Further, the second inner-effective-diameter area EI2 has a shape so that a light flux having passed through the second inner-effective-diameter area EI2 forms a light-converged spot on an information recording surface of the second optical information recording medium (not shown) under the condition that the aberration is corrected. On the other hand, the second outer-effective-diameter area EO2 has a shape of refractive interface so that a light flux having passed through the second outer-effective-aperture area EO2 forms a flare light on an information recording surface of the second optical information recording medium (not shown), thus, the second outer-effective-diameter area generates under-corrected aberration on the outside of the effective diameter as shown in FIG. 3(b).

In the more specific explanation of optical surface forms on both lens sections, θᵢ₁>θₒ₁ holds in the first objective lens section OL1, under the condition that θᵢ₁ represents a surface-normal angle on the outer edge (on effective diameter EA1) of the first inner-effective-diameter area EI1 and θₒ₁ represents a surface-normal angle on the inner edge (on effective diameter EA1) of the first outer-effective-diameter area EO1. By doing the foregoing, spherical aberration that becomes over-corrected on the outside of an effective diameter is obtained, but, the first outer-effective-diameter area EO1 results in a form that projects to the outside of the optical axis direction (left side in FIG. 2), compared with a form (illustrated by dotted lines) of the first inner-effective-diameter area EI1 extended. Incidentally, with respect to a surface-normal angle θᵢ₁ and θₒ₁, it is preferable that expression (1) stated later is satisfied. A diffractive structure that generates flare light may also be provided on the first outer-effective-diameter area EO1 in the same way.

On the other hand, θᵢ₂<θₒ₂ holds in the second objective lens section OL2, under the condition that θᵢ₂ represents a surface-normal angle on the outer edge (on effective diameter EA2) of the second inner-effective-diameter area EI2 and θₒ₂ represents a surface-normal angle on the inner edge (on effective diameter EA2) of the second outer-effective-diameter area EO2. By doing the foregoing, spherical aberration that becomes under-corrected on the outside of an effective diameter is obtained, but, the second outer-effective-diameter area EO2 results in a form that is drawn into the inside of the optical axis direction (right side in FIG. 2), compared with a form (illustrated by dotted lines) of the second inner-effective-diameter area EI2 extended. Incidentally, with respect to a surface-normal angle θᵢ₂ and θₒ₂, it is preferable that expression (2) stated later is satisfied. A diffractive structure that generates flare light may also be provided on the second outer-effective-diameter area EO2 in the same way.

In the second objective lens section OL2 that forms a light-converged spot on an information recording surface of the second optical information recording medium having a thicker substrate (t2), a curvature of the optical surface tends to be small, compared with the first objective lens section OL1 that forms a light-converging spot on an information recording surface of the first optical information recording medium having a thinner substrate (t1). Therefore, when the first outer-effective-diameter area EO1 and the second outer-effective-diameter area EO2 are made to be in a form such that the first inner-effective-diameter area EI1 and the second inner-effective-diameter area EI2 are extended respectively as shown with dotted lines in FIG. 2, the second outer-effective-diameter area EO2 intersects flange section FL at the position near the first objective lens section OL2. The form of this kind causes a difficulty in molding with the use of a die in the case of injection molding for optical element OE. As can be seen from FIG. 2, the first outer-effective-diameter area EO1 is particularly needed for securing moldability. When providing a lens surface form which looks like that a lens surface form of an area inside effective aperture shown by dotted lines is extended as it is, and trying to secure a minimum and necessary area of the first area outside effective diameter EO1, flange section FL′ becomes small (short in the direction perpendicular to optical axis), and molding of optical element OE becomes difficult. Further, when trying to secure only a minimum and necessary area in order to take a longer flange portion for a lens surface such that the first outer-effective-diameter area EO1 and the second outer-effective-diameter area EO2 form which looks like that the first and second areas inside effective diameter are extended as they are, a form of the flange section becomes tilt against optical axis or requires a step, which also makes molding of optical element OE difficult.

In contrast to the foregoing, the embodiment of the invention makes the first outer-effective-diameter area EO1 in a shape that stretches out in the direction away from the optical axis, compared with the form (illustrated by dotted lines) such that the first inner-effective-diameter area EI1 is extended, and makes the second outer-effective-diameter EO2 in a shape that stretches in the direction close to the optical axis, compared with the form (illustrated by dotted lines) such that the second inner-effective-diameter area EI2 is extended. Therefore, it allows to secure longer flange section FL, and to cause flange section FL to be perpendicular to the optical axis and to have no steps, and thereby to enhance moldability for optical element OE.

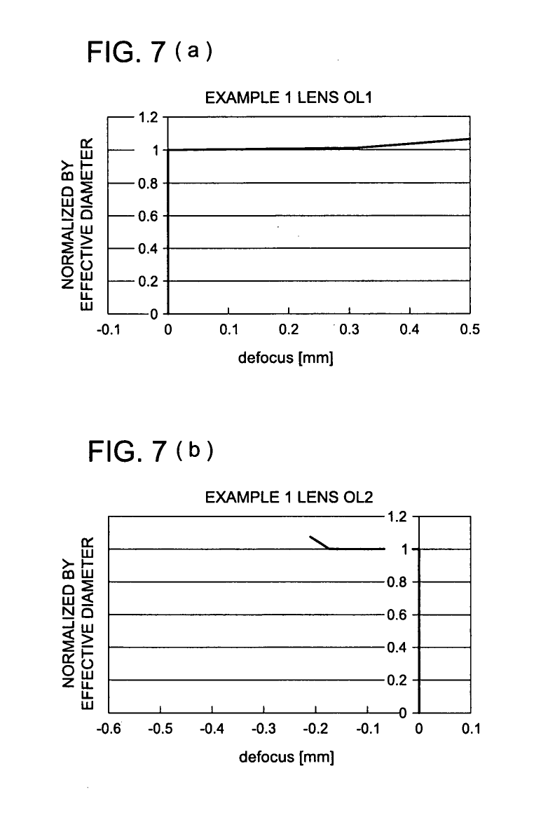

Incidentally, “a diameter” such as a first predetermined diameter or a second predetermined diameter mentioned in the present specification means a length in the direction perpendicular to the optical axis direction viewed in the optical axis direction. For example, the “diameter” means twice length of length of R1 and R2 shown in. FIG. 5. As shown in FIG. 5, L1 represents a distance between position DP1 (which corresponds to a first predetermined diameter) that is away from the surface peak TP1 by certain radius R1 and the surface peak TP1, on the optical surface on the light source side of the first objective lens portion OL1, and L2 represents a distance in the optical axis direction between position DP2 (which corresponds to a second determined diameter) that is away from surface peak TP2 by certain radius R2 and the surface peak TP2 in the optical surface on the light source side of the second objective lens section OL2. Incidentally, the distances L1 and L2 satisfies L1>L2. Further, it is preferable that each of R1 and R2 corresponds to an effective diameter.

The optical element in which the first objective lens section and the second objective lens section are formed in one body may includes one in which the first objective lens section and the second objective lens section are fused together (for example, the case where an optical element having the first objective lens section and the second objective lens section is obtained through injection molding). Additionally, it may further includes an optical element in which an optical element having the first objective lens section and an optical element having the second objective lens section are formed separately, and then, are fixed together to be one body.

When conducting recording and reproducing for the first optical information recording medium having a protective substrate thickness of t1 and the second optical information recording medium having a protective substrate thickness of t2 (t2>t1), by using an optical element relating to the invention, and when each of the first and the second objective lens sections is made of only a refracting interface, it is preferable that recording and reproducing for the first optical information recording medium is conducted by the first objective lens section in principle, and recording and reproducing for the second optical information recording medium is conducted by the second objective lens section. However, when the objective lens section has a diffractive structure or an optical path difference providing structure, or when a diffractive optical element or an optical path difference providing structure is incorporated in the optical element of the invention, the invention is not limited to the aforesaid embodiment.

In the optical pickup apparatus, the number of light sources is sometimes single, and is sometimes plural. For example, when realizing compatibility between BD and HD by using an optical element relating to the invention, it is possible to conduct recording and/or reproducing for BD on the first objective lens section, and for HD on the second objective lens section, by using a single light source emitting a light flux with a wavelength of 380 nm or more and 450 nm or less. Further, when realizing compatibility between DVD and CD by using an optical element of the invention, it is possible to conduct recording and/or reproducing for DVD on the first light source and the first objective lens section, and for CD on the second light source and the second objective lens section, by using two kinds of light sources including the first source emitting a light flux with a wavelength of 600 nm or more and 700 nm or less, and the second light source for CD emitting a light flux with a wavelength of 730 nm or more and 800 nm or less. Further, when realizing compatibility for BD, HD, DVD and CD by using the optical element of the invention, it is also possible to conduct recording and/or reproducing for BD with the first light source and the first objective lens section, for HD with the first light source and the second objective lens section, for DVD with the second light source and the second objective lens section and for CD with the third light source and the second objective lens section, by using three types of light sources including the first light source for BD and HD emitting a light flux having a wavelength of 380 nm or more and 450 nm or less, the second light source for DVD emitting a light flux having a wavelength of 600 nm or more and 700 nm or less, and the third light source for CD emitting a light flux having a wavelength of 730 nm or more and 800 nm or less.

In the first embodiment according to the present invention, the border defined by the first predetermined diameter and the border defined by the second predetermined diameter may be maximum effective diameters of the optical surface of the first objective lens section and the optical surface of the second objective lens section, respectively.

Incidentally, when achieving compatibility for plural types of optical information recording media by a single objective lens section, the maximum effective diameter means the greatest diameter among plural effective diameters. However, when a single objective lens section corresponds only to one type of optical information recording medium, its effective diameter is the maximum effective diameter.

In the first embodiment according to the present invention, the first optical information recording medium may comprise a protective substrate with a thickness of t1, and the second optical information recording medium may comprise a protective substrate with a thickens of t2 (t2>t1).

In this case, when the first objective lens section or the second objective lens section is an compatible lens that conducts recording and reproducing for plural optical information recording media with a single objective lens section, a thickness t1 or t2 of a protective substrate of an optical information recording medium is assumed to be the thinnest one among thicknesses of protective substrates of optical information recording media handled by a single objective lens portion representing an interchangeable lens. For example, when conducting recording and reproducing for BD with the first lens section and conducting recording and reproducing for HD, DVD and CD with the second lens section, t1 is a thickness of the protective substrate of BD, and t2 is a thickness of the protective substrate of HD or DVD.

In the first embodiment according to the present invention, the first outer area may make a light flux passing therethough over-flared compared with a converged light spot formed by a light flux passing through the first inner area, and the second outer area may make a light flux passing therethough under-flared compared with a converged light spot formed by a light flux passing through the second inner area.

In the meantime, “over-flared” is a situation that a light flux passing the outer area intersects the optical axis at the position that is farther from the objective lens section than a paraxial image point, in the spherical aberration diagram whose origin is at a paraxial image point position. Further, “under-flared” is a situation that a light flux passing the outer area intersects the optical axis at the position that is closer to the objective lens section than a paraxial image point, in the spherical aberration diagram whose origin is at a paraxial image point position.

In the first embodiment according to the present invention, the optical element for the optical pickup apparatus may satisfy at least one of the following expressions.
4°≦|θi1−θo1|≦18° (2)
4°≦|θi2−θo2|≦18° (3)

In the structure relating to the invention, it is possible to scatter unwanted light sufficiently as flare light, by making a surface-normal angle on the optical surface discontinuously within an appropriate range, thus, it is possible to satisfy specification NA and to form a spot excellent in optical performance, even when the optical pickup apparatus has no diaphragm. It is more preferable that the following expression is satisfied.
5°≦|θi1−θo1|≦8° (2′)

In the first embodiment according to the present invention, at least one of the first outer area and the second outer area may consist of a refractive surface. Thereby, processing man-hours for the aforesaid optical element for the optical pickup apparatus can be reduced. Incidentally, each of both of the first outer area and the second outer area may be a refracting interface.

In the first embodiment according to the present invention, the first outer area and the first inner area may be continuous. Thereby, workability of the aforesaid optical element for the optical pickup apparatus can be improved. The expression that “the outer area and the inner area are continuous” means that no excessive surface exists between the outer area and the inner area.

In the first embodiment according to the present invention, the second outer area and the second inner area may be continuous. Thereby, workability of the aforesaid optical element for the optical pickup apparatus can be improved.

In the first embodiment according to the present invention, at least one of the first outer area and the second outer area may comprise a diffractive structure. Thereby, the aforesaid optical element of the optical pickup apparatus can scatter flare light sufficiently while securing workability. In addition, by providing a diffractive structure on the aforesaid outer area, it is possible to scatter unwanted light on the outer area more effectively, and to prevent more effectively that recording and reproducing for optical information recording medium are affected by unwanted light. In other words, diaphragm effects can be enhanced more by providing a diffractive structure on the outer area.

In the first embodiment according to the present invention, at least one of the first inner area and the second inner area may comprise a diffractive structure. Thereby, the aforesaid optical element of the optical pickup apparatus can scatter flare light sufficiently while securing workability. In addition, by providing a diffractive structure on the inner area, it is possible to achieve an objective lens section of a compatible type capable of conducting recording and reproducing for plural types of optical information recording media with a single objective lens section. Further, by providing a diffractive structure on an inner area, it is possible to compensate spherical aberration caused by temperature changes (for example, within ±30° C.) and slight fluctuations of wavelength (for example, within ±10 nm).

In the first embodiment according to the present invention, the first predetermined diameter and the second predetermined diameter may have an almost same value. Herein, “the first predetermined diameter and the second predetermined diameter have an almost same value” means that the following conditional expression is satisfied.
0.95×R1≦R2≦1.05×R1 (4)
Where, R1 represents a predetermined diameter of the first objective lens section (first predetermined diameter) and R2 represents a predetermined diameter of the second objective lens section (second predetermined diameter).

In the first embodiment according to the present invention, the light source may comprise a first light source and a second light source, the first light source may emit a light flux with a wavelength λ1, for recording and/or reproducing information on the first optical information recording medium, and the second light source may emit a light flux with a wavelength λ2 (λ2>λ1), for recording and/or reproducing information on the second optical information recording medium.

A second embodiment according to the present invention, is an optical element for use in an optical pickup apparatus which comprises a single or a plurality of light source, and an optical element. The optical element comprises a first objective lens section and a second objective lens section formed in one body. The first objective lens section comprises an optical surface divided by a border defined by a first predetermined diameter into a first inner area and a first outer area. The first inner area is arranged on an inside of the border in a direction perpendicular to an optical axis and has a surface-normal angle θi1 at an outer edge thereof. The first outer area is arranged on an outside of the border in the direction perpendicular to the optical axis and has a surface-normal angle θo1 at an inner edge thereof. The angle θi1 is larger than the angle θo1. The second objective lens section comprises an optical surface divided by a border defined by a second predetermined diameter into a second inner area and a second outer area. The second inner area is arranged on an inside of the border in a direction perpendicular to an optical axis and has a surface-normal angle θi2 at an outer edge thereof. The second outer area is arranged on an outside of the border in the direction perpendicular to the optical axis and has a surface-normal angle θo2 at an inner edge thereof. The angle θi2 is smaller than the angle θo2. In the optical pickup apparatus, the first objective lens section converges a light flux from the light source onto an information recording surface of a first optical information recording medium comprising a protective substrate whose thickness is t1 to record and/or information on the information recording surface of the first optical information recording medium, and the second objective lens section converges a light flux from the light source onto an information recording surface of a second optical information recording surface of a second optical information recording medium comprising a protective substrate whose thickness is t2 (t1<t2) to record and/or information on the information recording surface of the second optical information recording medium.

In this case, when the first objective lens section or the second objective lens section is an compatible lens that conducts recording and reproducing for plural optical information recording media with a single objective lens section, a thickness t1 or t2 of a protective substrate of an optical information recording medium is assumed to be the thinnest one among thicknesses of protective substrates of optical information recording media handled by a single objective lens portion representing an interchangeable lens. For example, when conducting recording and reproducing for BD with the first lens section and conducting recording and reproducing for HD, DVD and CD with the second lens section, t1 is a thickness of the protective substrate of BD, and t2 is a thickness of the protective substrate of HD or DVD.

In the second embodiment according to the present invention, each of the first objective lens section and the second objective lens section may consist of a refractive surface.

The third embodiment according to the present invention is an optical pickup apparatus comprising: a light source; and the optical element of any one of the first and the second embodiments. It is preferable that a component that carries out a function of a diaphragm is not arranged in the optical pickup apparatus relating to the invention. The reason for the foregoing is that an appropriate optical performance can be secured without such component, because the outer area of the optical element carries out a function of a diaphragm.

In the third embodiment according to the present invention, the optical pickup apparatus may further comprise: a mirror arranged in an optical path between the optical element and the light source. When the optical pickup apparatus records and/or reproduce information on the first optical information recording medium, the mirror may reflect a light flux such that the light flux passes through the first objective lens section. When the optical pickup apparatus records and/or reproduce information on the second optical information recording medium, the mirror may reflect a light flux such that the light flux passes through the second objective lens section. In the embodiment, a maximum diameter of a light flux at a surface of the mirror when information is recorded and/or reproduced by the first objective lens section may have an almost same value to a maximum diameter of a light flux at a surface of the mirror when information is recorded and/or reproduced by the second objective lens section.

It is preferable that a mirror used in an optical pickup apparatus relating to the invention is a so-called deflecting mirror which bends up the incident light. The maximum light flux diameter on the mirror surface is the largest diameter among light flux diameters on the mirror surface, when the first objective lens section or the second objective lens section handles plural types of optical information recording media compatibly with a single objective lens section. However, when conducting recording and reproducing for only one type of optical information recording medium with a single objective lens section, its light flux diameter corresponds to the maximum light flux diameter. Incidentally, the light flux diameter on the mirror surface means a diameter of a surface area on the mirror surface of the light flux passing through an effective diameter of an optical element having the first objective lens section and the second objective lens section. The expression that “a maximum diameter of a light flux at a surface of the mirror when information is recorded and/or reproduced by the first objective lens section has an almost same value to a maximum diameter of a light flux at a surface of the mirror when information is recorded and/or reproduced by the second objective lens section” means that the following conditional expression is satisfied.
0.95×R10≦R20≦1/05×R10
Where, R10 represents the maximum light flux diameter on the mirror surface in the case of using the first optical lens section, while, R20 represents the maximum light flux diameter on the mirror surface in the case of using the second optical lens section.

The fourth embodiment according to the present invention is an optical element for use in an optical pickup apparatus which comprises a single or a plurality of light source, an optical element, and a single or a plurality of objective lens. The optical element comprises: a first coupling lens section and a second coupling lens section formed in one body. The first coupling lens section comprises an optical surface divided by a border defined by a first predetermined diameter into a first inner area and a first outer area. The first inner area is arranged on an inside of the border in a direction perpendicular to an optical axis and has a surface-normal angle θi1 at an outer edge thereof. The first outer area is arranged on an outside of the border in the direction perpendicular to the optical axis and has a surface-normal angle θo1 at an inner edge thereof. The angle θi1 is larger than the angle θo1. The second coupling lens section comprises an optical surface divided by a border defined by a second predetermined diameter into a second inner area and a second outer area. The second inner area is arranged on an inside of the border in a direction perpendicular to an optical axis and has a surface-normal angle θi2 at an outer edge thereof. The second outer area is arranged on an outside of the border in the direction perpendicular to the optical axis and has a surface-normal angle θo2 at an inner edge thereof. The angle θi2 is smaller than the angle θo2. In the optical pickup apparatus, the first coupling lens section makes a light flux from the light source incident to the objective lens so that the objective lens converges the light flux onto an information recording surface of a first optical information recording medium to record and/or information on the information recording surface of the first optical information recording medium, and the second coupling lens section makes a light flux from the light source incident to the objective lens so that the objective lens converges a light flux from the light source onto an information recording surface of a second optical information recording surface of a second optical information recording medium to record and/or information on the information recording surface of the second optical information recording medium.

The optical element satisfies the following expression.
L1>L2 (1)
Where, L1 is a distance in a direction of the optical axis from a peak of the optical surface of the first coupling lens section to the border defined by a first predetermined diameter, and L2 is a distance in a direction of the optical axis from a peak of the optical surface of the second coupling lens section to the border defined by a second predetermined diameter.

The fifth embodiment according to the present invention is an optical element for use in an optical pickup apparatus which comprises a single or a plurality of light source, an optical element, and a single or a plurality of objective lens. The optical element comprises: a first coupling lens section and a second coupling lens section formed in one body. The first coupling lens section comprises an optical surface divided by a border defined by a first predetermined diameter into a first inner area and a first outer area. The first inner area is arranged on an inside of the border in a direction perpendicular to an optical axis and has a surface-normal angle θi1 at an outer edge thereof. The first outer area is arranged on an outside of the border in the direction perpendicular to the optical axis and has a surface-normal angle θo1 at an inner edge thereof. The angle θi1 is larger than the angle θo1. The second coupling lens section comprises an optical surface divided by a border defined by a second predetermined diameter into a second inner area and a second outer area. The second inner area is arranged on an inside of the border in a direction perpendicular to an optical axis and having a surface-normal angle θi2 at an outer edge thereof. The second outer area is arranged on an outside of the border in the direction perpendicular to the optical axis and has a surface-normal angle θo2 at an inner edge thereof. The angle θi2 is smaller than the angle θo2. In the optical pickup apparatus, the first coupling lens section makes a light flux from the light source incident to the objective lens so that the objective lens converges the light flux onto an information recording surface of a first optical information recording medium comprising a protective substrate whose thickness is t1 to record and/or information on the information recording surface of the first optical information recording medium, and the second coupling lens section makes a light flux from the light source incident to the objective lens so that the objective lens converges a light flux from the light source onto an information recording surface of a second optical information recording surface of a second optical information recording medium comprising a protective substrate whose thickness is t2 (t1<t2) to record and/or information on the information recording surface of the second optical information recording medium.

Each optical element of the fourth and fifth embodiments is not an objective lens, but is a coupling lens such as a collimator lens. The optical element of the fifth and sixth embodiments is the substantially same as each optical element of the first and second embodiment, except that it is not an objective lens, but is a coupling lens such as a collimator lens, and the explanations in FIGS. 1 and 2 can be applied equally also to the optical elements of the fourth and sixth embodiments. Incidentally, the coupling lens is a lens that is arranged between the light source and the objective optical element, and changes a degree of divergence of a light flux. The collimator lens is a kind of coupling lens, and it is a lens which makes the incident light flux to be in parallel to emerge.

The sixth embodiment according to the present invention is an optical pickup apparatus comprising: the optical element of any one of the fourth and fifth embodiments.

The optical element relating to the invention may either be made of plastic or be made of glass, and it is preferable that it is made of plastic. Further, when two lenses are caused to fit together, a combination of glass and plastic is also accepted.

The invention makes it possible to provide an optical pickup apparatus wherein recording and/or reproducing of information can be conducted for different optical discs by using an optical element for an optical pickup apparatus composed of two lenses formed in one body, the optical pickup apparatus can be made to be more compact by causing the two lenses to be equal in terms of a diameter at their lens sections, and molding is conducted easily, and providing of a separate component having diaphragm function on the optical pickup apparatus is not necessary, by making the flange portions to be equal.

An embodiment of the invention will be explained as follows, referring to the drawings. Incidentally, an optical pickup apparatus PU1 relating to the present embodiment can be incorporated in an optical disc drive apparatus.

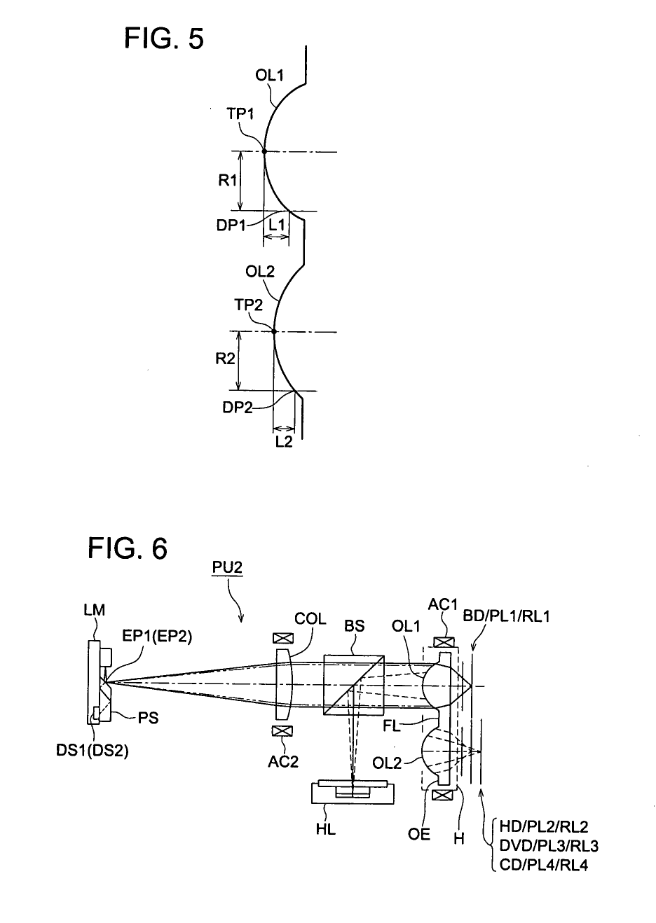

FIG. 4 is a diagram showing schematically the structure of optical pickup apparatus PU1 capable of conducting recording/reproducing of information properly for both of DVD and CD. Optical specifications of DVD include wavelength λ2=655 nm, thickness t3=0.6 mm for protective substrate PL3 and numerical aperture NA3=0.65. Optical specifications of CD include wavelength λ4=785 nm, thickness t4=1.2 mm for protective substrate PL4 and numerical aperture NA4=0.51. However, a combination of the wavelength, the thickness of a protective substrate and the numerical aperture is not limited to the foregoing.

The optical pickup apparatus PU1 has laser module LM that is composed of first light-emitting point EP1 (first light source) that emits red laser light flux (first light flux) that is emitted when conducting recording/reproducing of information for DVD and has a wavelength of 655 nm; second light-emitting point EP2 (second light source) that emits laser light flux (second light flux) that is emitted when conducting recording/reproducing of information for CD and has a wavelength of 785 nm; first light-receiving section DS1 that receives a light flux reflected from information recording surface RL3 of DVD; second light-receiving section DS2 that receives a light flux reflected from information recording surface RL4 of CD; and of prism PS. Further, optical element OE is composed of first objective lens section OL1 and second objective lens section OL2 which have the same forms as those shown in FIGS. 1 and 2, and are formed in one body. The optical element OE is supported by holding member H that is driven by actuator AC1 to be movable. Though an optical surface of each of the first objective lens section OL1 and the second objective lens section OL2 is composed of a refracting interface alone, it is also possible to include a diffractive structure.

When conducting recording/reproducing of information for DVD, in optical pickup apparatus PU1, holding member H is moved to the position shown in FIG. 4, first objective lens section OL1 is inserted in the optical path and the first light-emitting point EP1 is caused to emit light. A divergent light flux emitted from the first light-emitting point EP1 is converted into a parallel light flux by collimator COL as its ray path is drawn with solid lines in FIG. 4 to enter the first objective lens section OL1 under the condition of a parallel beam. Then, the light flux that has passed through the first inner-effective diameter area becomes a spot that is formed on information recording surface RL3 through protective substrate PL3 of DVD. While, the light flux that has passed through the first outer-effective diameter area becomes flare light. Thus, a function of diaphragm is exhibited. First objective lens section OL1 is driven by biaxial actuator AC1 together with holding member H so that focusing and tracking are carried out. Though the objective lens section moves in the structure in the present example, it is also possible to arrange so that the objective lens section is fixed, and an optical path is made to be different for each light source.

A reflected light flux modulated by information pits on information recording surface RL3 passes again through the first objective lens section OL1 and collimator COL. Then, the reflected light enters laser module LM, and is converged on the first light-receiving section DS1 after being reflected twice in a prism. Thus, information recorded on DVD can be read by using output signals of the first light-receiving section DS1.

When conducting recording/reproducing of information for CD, in optical pickup apparatus PU1, holding member H is moved upward from the position shown in FIG. 4, second objective lens section OL2 is inserted in the optical path, then, collimator COL is moved by uniaxial actuator AC2 in the optical axis direction and the second light-emitting point EP2 is caused to emit light. A divergent light flux emitted from the second light-emitting point EP2 is converted into a slightly divergent light flux by collimator COL, whose ray path is not illustrated in FIG. 4, enters the second objective lens section OL2 under the condition of a finite divergent light flux. The light flux that has passed through the second inner-effective diameter area becomes a spot formed on information recording surface RL4 through protective substrate PL4 of CD, while, a light flux having passed through the second outer-effective diameter area becomes under-flared light. Thus, a function of diaphragm is exhibited. Objective lens section OL2 is driven by biaxial actuator AC1 together with holding member H so that focusing and tracking are carried out.

A reflected light flux modulated by information pits on information recording surface RL4 passes again through the second objective lens section OL2 and collimator COL. Then, the reflected light flux enters laser module LM, and is converged on the second light-receiving section DS2 after being reflected twice in a prism. Thus, information recorded on CD can be read by using output signals of the second light-receiving section DS2.

That is, in the first objective lens section OL1, when DVD is used, a ray of light that has passed through the outer-effective diameter area formed to be similar to EO1 shown in FIG. 2 becomes flare light. Further, in the second objective lens section OL2, when CD is used, a ray of light that has passed through the outer-effective diameter area formed to be similar to EO2 shown in FIG. 2 becomes flare light. Incidentally, an effective diameter of the first objective lens section OL1 and that of the second objective lens section OL2 are established to be equal to each other.

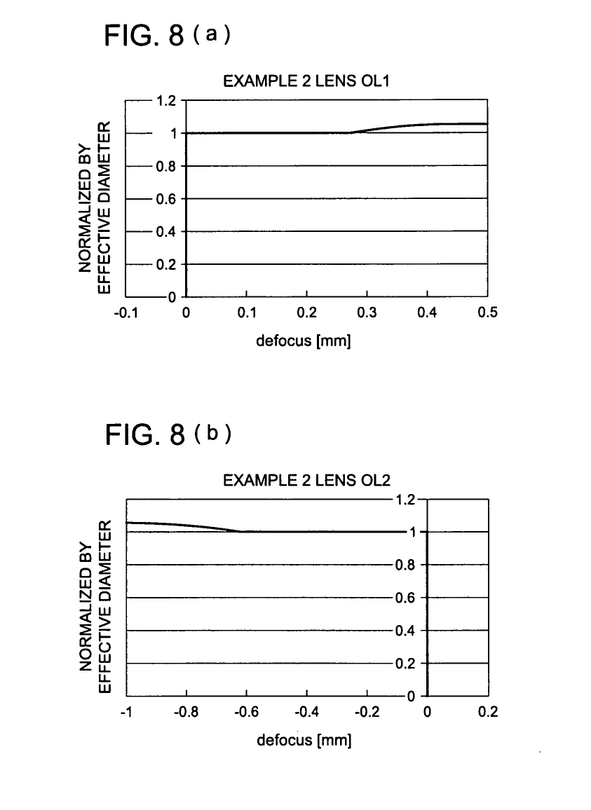

FIG. 6 is a diagram showing schematically the structure of optical pickup apparatus PU2 capable of conducting recording/reproducing of information properly for all of BD, HD, DVD and CD. Optical specifications of BD include wavelength λ1=407 nm, thickness t1=0.1 mm for protective substrate PL1 and numerical aperture NA1=0.85. Optical specifications of HD include wavelength λ1=407 nm, thickness t2=0.6 mm for protective substrate PL2 and numerical aperture NA2=0.65, optical specifications of DVD include wavelength λ2=655 nm, thickness t3=0.6 mm for protective substrate PL3 and numerical aperture NA3=0.65. Optical specifications of CD include wavelength λ4=785 nm, thickness t4=1.2 mm for protective substrate PL4 and numerical aperture NA4=0.51. However, a combination of the wavelength, the thickness of a protective substrate and the numerical aperture is not limited to the foregoing.

Optical pickup apparatus PU2 has laser module LM composed of first light-emitting point EP1 (first light source) that emits violet laser light flux (first light flux) with wavelength 407 nm emitted in conducting recording and reproducing of information for BD and HD; second light-emitting point EP2 (second light source) that emits laser light flux (second light flux) with wavelength 655 nm emitted in conducting recording/reproducing of information for DVD; first light-receiving section DS1 that receives reflected light flux coming from information recording surfaces RL1 and RL2 of BD and HD; second light-receiving section DS2 that receives reflected light flux coming from information recording surfaces RL3 of DVD and prism PS; and hologram laser HL representing a light-emitting and light-receiving sections integrated light source unit wherein the third light source emitting a laser light flux (third light flux) with wavelength 785 nm when conducting recording/reproducing of information for CD and a photodetector are integrated solidly. Further, optical element OE is composed of the first objective lens section OL1 and the second objective lens section OL2 which have the same forms as those shown in FIGS. 1 and 2 and are formed in one body. The optical element OE is held by holding member H that is driven by actuator AC1 to be movable. Incidentally, inside an effective diameter on the optical surface of the second objective lens section OL, there may also be formed a diffractive structure for realizing compatibility for HD, DVD and CD. It is further possible to provide a diffractive structure that compensates spherical aberration in the case of temperature changes and humidity changes, on the first objective lens section or the second objective lens section. With respect to a size of the effective diameter of the second objective lens section OL2, the smallest one is the effective diameter for CD, a medium one is the effective diameter for HD and the largest one is the effective diameter for DVD. The inside of the effective diameter on the optical surface of the second objective lens section OL2 means the inside of the effective diameter for DVD, namely, the inside of the maximum effective diameter. In the area which is inside the maximum effective diameter and is outside the effective diameter for HD, there may include a diffractive structure that scatters a light flux passing through this area as flare light, when conducting recording and reproducing for HD and CD. Further, in the area which is inside an effective diameter for HD and is outside an effective diameter for CD, there may be provided a diffractive structure that scatters a light flux passing through this area as flare light, when conducting recording and reproducing for CD.

When conducting recording/reproducing of information for BD, in optical pickup apparatus PU2, holding member H is moved to the position shown in FIG. 6, first objective lens section OL1 is inserted in the optical path and the first light-emitting point EP1 is caused to emit light. A divergent light flux emitted from the first light-emitting point EP1 is converted into a parallel light flux by collimator COL as its ray path is drawn with solid lines in FIG. 6 to pass through beam splitter BS. After entering the first objective lens section OL1 under the condition of a parallel light flux, the light flux that has passed through the first inner-effective diameter area becomes a spot that is formed on information recording surface RL1 through protective substrate PL1 of BD, while the light flux that has passed through the first outer-effective diameter area becomes over-flared light. Thus, a function of diaphragm is exhibited. First objective lens section OL1 is driven by biaxial actuator AC1 together with holding member H so that focusing and tracking are carried out.

A reflected light flux modulated by information pits on information recording surface RL1 passes again through the first objective lens section OL1, beam splitter BS and collimator COL, then, enters laser module LM. Then, the reflected light flux is converged on the first light-receiving section DS1 after being reflected twice in a prism. Thus, information recorded on BD can be read by using output signals of the first light-receiving section DS1. Spherical aberration caused by temperature changes in the course of recording and reproducing for BD, and spherical aberration caused by the use of a two-layer disc are corrected by driving collimator COL.

When conducting recording/reproducing of information for HD, in optical pickup apparatus PU2, holding member H is moved upward from the position shown in FIG. 6, second objective lens section OL2 is inserted in the optical path and the first light-emitting point EP1 is caused to emit light. A divergent light flux emitted from the first light-emitting point EP1 is converted into a parallel light flux by collimator COL, whose ray path is omitted in FIG. 6, to pass through beam splitter BS. Then, the light flux enters the second objective lens section OL2 under the condition of a parallel light, and the light flux becomes a spot that is formed on information recording surface RL2 through protective substrate PL2 of HD. Incidentally, even in the second inner-effective diameter area, the light flux that has passed through the outside area of the effective diameter for HD is caused to be flare light by the function of the diffractive structure. Since the light flux having passed through the second outer-effective diameter area becomes flare light, a function of diaphragm is exhibited accordingly. Second objective lens section OL2 is driven by biaxial actuator AC1 together with holding member H so that focusing and tracking are carried out.

A reflected light flux modulated by information pits on information recording surface RL2 passes again through the second objective lens section OL2, beam splitter BS and collimator COL. Then, the reflected light flux enters laser module LM, and is converged on the first light-receiving section DS1 after being reflected twice in a prism. Thus, information recorded on HD can be read by using output signals of the first light-receiving section DS1.

In the second objective lens section OL2, an effective diameter for HD is smaller than that for DVD. Namely, when HD is used, flare light is generated by an optical surface area representing a diffractive surface used only for DVD, and when DVD is used, a ray passing through the outer-maximum-effective diameter area becomes under-flared light, whereby, a function of diaphragm is exhibited.

When conducting recording/reproducing of information for DVD, in optical pickup apparatus PU2, holding member H is moved upward from the position shown in FIG. 6, second objective lens section OL2 is inserted in the optical path, and collimator COL is moved by uniaxial actuator AC2 in the optical axis direction, and the second light-emitting point EP2 is caused to emit light. A divergent light flux emitted from the second light-emitting point EP2 is converted into a slightly divergent light flux by collimator COL as its ray path is drawn with solid lines in FIG. 6, and it passes through beam splitter BS and enters the second objective lens section OL2 under the condition of a finite convergent light flux. Thus, the light flux having passed through the second inner-effective diameter area (inner-maximum-effective diameter area) becomes a spot formed on information recording surface RL3 through protective substrate PL3 of DVD. In contrast to this, a light flux having passed through the second outer-effective diameter area becomes under-flared light, which exhibits a function of diaphragm. Second objective lens section OL2 is driven by biaxial actuator AC1 together with holding member H so that focusing and tracking are carried out.

A reflected light flux modulated by information pits on information recording surface RL3 passes again through the second objective lens section OL2, beam splitter BS and collimator COL, then, enters laser module LM, and is converged on the second light-receiving section DS2 after being reflected twice in a prism. Thus, information recorded on DVD can be read by using output signals of the second light-receiving section DS2.

When conducting recording/reproducing of information for CD, in optical pickup apparatus PU2, holding member H is moved upward from the position shown in FIG. 6, second objective lens section OL2 is inserted in the optical path and hologram laser HL is caused to emit light. A divergent light flux emitted from the hologram laser HL is reflected by beam splitter BS as its ray path is drawn with dotted lines in FIG. 6, and it becomes a spot formed on information recording surface RL4 through protective substrate PL4 of CD, after entering the second objective lens section OL2 under the condition of finite divergent light flux. Incidentally, even in the second inner-effective diameter area, the light flux that has passed through the outside area of the effective diameter for CD is caused to be flare light by the function of the diffractive structure. Since the light flux having passed through the second outer-effective diameter area becomes under-flared light, a function of diaphragm is exhibited accordingly. Second objective lens section OL2 is driven by biaxial actuator AC1 together with holding member H so that focusing and tracking are carried out.

A reflected light flux modulated by information pits on information recording surface RL4 is reflected again by the second objective lens section OL2 and by beam splitter, and then, enters hologram laser HL and is converged on light-receiving surface of a photodetector. Thus, information recorded on CD can be read by using output signals of the photodetector.

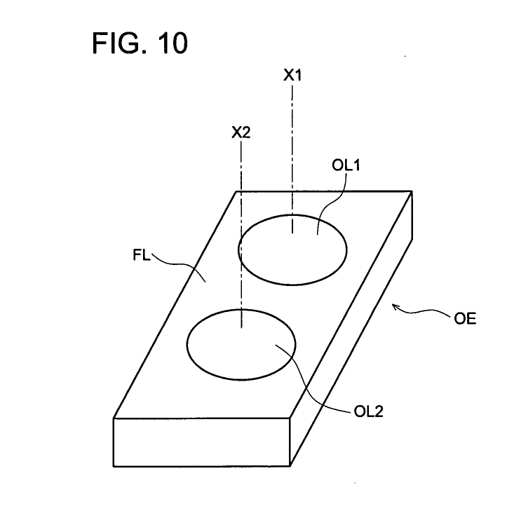

FIG. 11 is a diagram showing schematically the structure of optical pickup apparatus PU3 wherein deflecting mirror ML1 is arranged in an optical path between collimator lens COL and optical element OE, and recording and or reproducing of information can be conducted properly for both of DVD and CD. Since this structure excluding the deflecting mirror ML1 is the same as that of PU1 shown in FIG. 4, an explanation for that will be omitted.

When conducting recording/reproducing of information for DVD, in optical pickup apparatus PU2, holding member H is moved to the position shown in FIG. 11, first objective lens section OL1 is inserted in the optical path and the first light-emitting point EP1 is caused to emit light. A divergent light flux emitted from the first light-emitting point EP1 is converted into a parallel light flux by collimator COL as its ray path is drawn with solid lines in FIG. 11. Then, the light flux is reflected by deflecting mirror ML1, and enters the first objective lens section OL1 under the condition of a parallel light. The light flux having passed through the first inner-effective diameter area becomes a spot formed on information recording surface RL3 through protective substrate PL3 of DVD, while, the light flux having passed the first outer-effective diameter area becomes over-flared light, thereby, a function of diaphragm is exhibited.

A reflected light flux modulated by information pits on information recording surface RL3 passes again through the first objective lens section OL1, then, is reflected by deflecting mirror ML1, and is transmitted through collimator COL to enter laser module LM. After that, it is reflected twice in the prism to be converged on the first light-receiving section DS1. Thus, information recorded on DVD can be read by using output signals of the first light-receiving section DS1.

When conducting recording/reproducing of information for CD, in optical pickup apparatus PU3, holding member H is moved leftward from the position shown in FIG. 11, second objective lens section OL2 is inserted in the optical path, then, collimator COL is moved by uniaxial actuator AC2 in the optical axis direction and the second light-emitting point EP2 is caused to emit light. A divergent light flux emitted from the second light-emitting point EP2 is converted into a slightly divergent light flux by collimator COL, whose ray path is not illustrated in FIG. 11. Then, the light flux is reflected by deflecting mirror ML1, and enters the second objective lens section OL2 under the condition of a finite divergent light flux. The light flux that has passed through the second inner-effective diameter area becomes a spot formed on information recording surface RL4 through protective substrate PL4 of CD, while, a light flux having passed through the second outer-effective diameter area becomes under-flared light, thus, a function of diaphragm is exhibited.

A reflected light flux modulated by information pits on information recording surface RL4 is transmitted again through the second objective lens section OL2, and is reflected by deflecting mirror ML1. Then, the light flux is transmitted through collimator COL, and enters laser module LM and then, is reflected twice in the prism to be converged on the second light-receiving section DS2. Thus, information recorded on CD can be read by using output signals of the second light-receiving section DS2.

In other words, when DVD is used in the first objective lens section OL1, a ray having passed through an outer-effective diameter area that is formed to be the same as that for EO1 shown in FIG. 2 becomes flare light. Further, in the second objective lens section OL2, when CD is used, a ray having passed through an outer-effective diameter area that is formed to be the same as that for EO2 shown in FIG. 2 becomes flare light. In the meantime, effective diameters for the first objective lens section OL1 and the second objective lens section OL2 are established to be equal each other.

Incidentally, the maximum diameter of a light flux on the surface of deflecting mirror ML1 in the case of conducting recording and/or reproducing for DVD by using the first objective lens section OL1 is substantially the same as the maximum diameter of a light flux on the surface of deflecting mirror ML1 in the case of conducting recording and/or reproducing for CD by using the second objective lens section OL2. In the meantime, for both of DVD and CD, it is more preferable that the maximum diameters of light fluxes on deflecting mirrors are substantially the same when magnifications for objective lens sections are substantially the same.

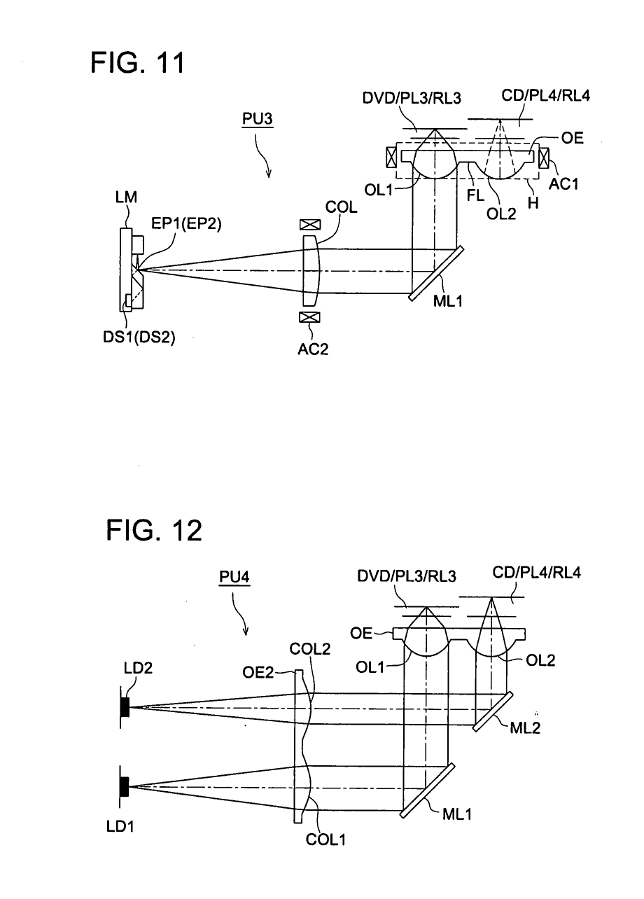

Next, FIG. 12 us a schematic diagram showing the structure of PU4 employing the optical element of the invention as a collimator lens.

Optical pickup apparatus PU4 includes therein laser module LD1 wherein first semiconductor laser (first light source) that emits a red laser light flux (first light flux) with wavelength of 655 nm radiated when conducting recording/reproducing of information for DVD and a first light-receiving section that receives reflected light flux coming from information recording surface RL3 of DVD are united in one body. Optical pickup apparatus PU4 further includes therein laser module LD2 wherein the second semiconductor laser (second light source) that emits a laser light flux (second light flux) with wavelength of 785 nm radiated when conducting recording/reproducing of information for CD and the second light-receiving section that receives a reflected light flux coming from information recording surface RL4 of CD are united in one body. Further, optical element OE is composed of the first objective lens section OL1 and the second objective lens section OL2 which have forms identical to those shown in FIGS. 1 and 2 and are formed in one body, and it is driven by an unillustrated actuator to be movable. An optical surface of each of the first objective lens section OL1 and the second objective lens section OL2 is composed only of a refractive interface, and a diffractive structure may also be provided on the optical surface.

Further, optical pickup apparatus PU4 has optical element OE2 wherein the first collimator lens section COLL and the second collimator lens section COL2 are formed in one body. The basic principle of this optical element OE2 is the same as those shown in FIGS. 1 and 2. An optical surface of the first collimator lens section COLL is divided into two areas by a border defined by an effective diameter of DVD: a first inner-effective diameter area which is inside an effective diameter in the direction perpendicular to the optical axis against; and the first outer-effective diameter area which outside the effective diameter in the direction perpendicular to the optical axis against the border. Where, surface-normal angle θi1 on an outer edge of the first inner-effective diameter area is greater than surface-normal angle θo1 on an inner edge of the first outer-effective diameter area. An optical surface of the second collimator lens section COL2 is divided into two areas by a border defined by the effective diameter: a second inner-effective diameter area that is inside the effective diameter in the direction perpendicular to the optical axis against the border; and the second outer-effective diameter area that is outside the effective diameter in the direction perpendicular to the optical axis against the border. Where, surface-normal angle θi2 on an outer edge of the second inner-effective diameter area is smaller than surface-normal angle θo2 on an inner edge of the second outer-effective diameter area. Further, when L1 represents a distance from a peak of the first collimator lens section COL1 to the effective diameter in the optical axis direction, and L2 represents a distance from a peak of the second collimator lens section COL2 to the effective diameter in the optical axis direction, L1>L2 is satisfied. In the present example, the first objective lens section and the second objective lens section in the optical element OE may also be separate optical elements, without being formed in one body.

When conducting recording/reproducing of information for DVD in optical pickup apparatus PU4, the first light source LD1 is caused to emit light. A divergent light flux emitted from the first light source LD1 is converted into a parallel light flux by collimator COL1. Since a light flux having passed through the first outer-effective diameter area of collimator COL1 becomes over-flared light, a function of diaphragm is exhibited. A light flux having passed through the first inner-effective diameter area of collimator COL1 is converted into a parallel light, and is reflected by deflecting mirror ML1. The reflected light enters the first objective lens section OL1 under the condition of a parallel light. The light flux having passed through the first inner-effective diameter area becomes a spot formed on information recording surface RL3 through protective substrate PL3 of DVD, while the light flux having passed through the first outer-effective diameter area becomes over-flared light, thus, a function of diaphragm is exhibited. The first objective lens section OL1 is driven by an unillustrated biaxial actuator, so that focusing and tracking are carried out.

A reflected light flux modulated by information pits on information recording surface RL3 is transmitted through the first objective lens section OL1 again, then is reflected by deflecting mirror ML1, and is converged on the first light-receiving section LD1 after being transmitted through collimator COLL. Thus, information recorded on DVD can be read by using output signals of the first light-receiving section DS1.

When conducting recording/reproducing of information for CD in optical pickup apparatus PU4, the second light source LD2 is caused to emit light. A divergent light flux emitted from the second light source LD2 is converted into a parallel light flux by collimator COL2. Since a light flux having passed through the second outer-effective diameter area of collimator COL2 becomes under-flared light, a function of diaphragm is exhibited. A light flux having passed through the second inner-effective diameter area of collimator COL2 is converted into a parallel light, and is reflected by deflecting mirror ML2. The reflected light enters the second objective lens section OL2 under the condition of a parallel light. Then, the light flux having passed through the second inner-effective diameter area becomes a spot formed on information recording surface RL4 through protective substrate PL4 of CD, while the light flux having passed through the second outer-effective diameter area becomes under-flared light, thus, a function of diaphragm is exhibited. The second objective lens section OL2 is driven by an unillustrated biaxial actuator, so that focusing and tracking are carried out.

A reflected light flux modulated by information pits on information recording surface RL4 is transmitted through the second objective lens section OL2 again, then is reflected by deflecting mirror ML2, and is converged on the second light-receiving section LD2 after being transmitted through collimator COL2. Thus, information recorded on CD can be read by using output signals of the second light-receiving section DS2.

In FIG. 12, an optical element in which a first collimator lens section and a second collimator lens section is formed integrally is used as collimator lenses and an optical element in which a first objective lens section and a second objective lens section is formed integrally is used as objective lenses. In addition to this example, an optical pickup apparatus comprising an optical element in which a first collimator lens section and a second collimator lens section are formed integrally as same as OE2 in FIG. 12 and two objective lenses which are a first objective lens and a second objective lens not formed integrally can be used. In such embodiment, flexibility for positioning objective lenses with regard to the position of collimator lenses would increase.

### EXAMPLE

A preferred example for an optical axis used for the aforesaid optical pickup apparatus will be explained as follows. Incidentally, from now on (including lens data in Table), it is assumed that an exponent of 10 (for example, 2.5×10⁻³) is expressed by using E (for example, 2.5E-3).

Each of optical surfaces of the first objective lens section and the second objective lens section is formed to be an aspheric surface that is stipulated by the numerical expression wherein a coefficient shown in Table is substituted in Numeral 1, and is axially symmetric about the optical axis.

$$X ( h ) = \frac{( {h}^{2} / r )}{1 + \sqrt{1 - ( 1 + κ ) {( h / r )}^{2}}} + {\sum }_{i = 0}^{10} {B}_{2 i} {h}^{2 i } \qquad [ Numeral 1 ]$$

In the expression above, X(h) represents an axis in the optical axis direction (traveling direction of light is positive), κ represents a conic constant, B₂ᵢ represents an aspheric surface coefficient and h represents a height from the optical axis.

In the case of Example employing a diffractive structure (phase structure), an optical path difference given by the diffractive structure to a light flux having each wavelength is stipulated by the numerical expression wherein a coefficient shown in Table is substituted in an optical path difference function of Numeral 2.

$$Φ ( h ) = λ / {λ}_{B} \times dor \times {\sum }_{i = 0}^{5} {C}_{2 i} {h}^{2 i} \qquad [ Numeral 2 ]$$

The symbol λ represents a wavelength of an incident light flux, λB represents a manufacture wavelength (blaze wavelength), d or represents a diffraction order and C₂ᵢ represents a coefficient of the optical path difference function.

### Example 1

Example 1 is used preferably for the aforesaid optical pickup apparatuses PU1, PU3 and PU4. Lens data of the first objective lens section relating to Example 1 are shown in Table 1, and lens data of the second objective lens section are shown in Table 2. FIG. 7(a) is a longitudinal spherical aberration diagram of the first objective lens section relating to Example 1, and FIG. 7(b) is a longitudinal spherical aberration diagram of the second objective lens section relating to Example 1, and each longitudinal axis is normalized by an effective diameter (maximum value of effective diameter represents 1 in longitudinal axis, and so forth).

TABLE 1
Example 1 Lens 1

| | | | | Optical |
|---|---|---|---|---|
| | | di | ni | element |
| i^{th} surface | ri | (660 nm) | (660 nm) | name |
| 0 | | ∞ | | |
| 1 | ∞ | 0.0 | | |
| (Diaphragm | | (φ0.85 mm) | | |
| diameter) | | | | |
| 2 | 0.8777 | 1.00000 | 1.53956 | Objective |
| 2′ | 0.8777 | 0.03613 | | lens |
| 3 | −2.1614 | 0.41 | 1.0 | |
| 4 | ∞ | 0.6 | 1.57718 | Disc |
| 5 | ∞ | | 1.0 | |

* The symbol di represents a displacement from i^{th} surface to (i + 1)^{th} surface.
* di′ represents a displacement from di′^{th} surface to i^{th} surface.

2^{nd} surface (0 mm≦h≦0.85 mm)

Aspheric surface coefficient

| | |
|---|---|
| κ | −2.5438E−01 |
| B4 | −3.8687E−02 |
| B6 | −4.9404E−02 |
| B8 | −9.6831E−02 |
| B10 | 2.3289E−01 |
| B12 | −3.0044E−01 |
| B14 | 1.2196E−02 |

2′^{th} surface (0.85 mm<h)

Aspheric surface coefficient

| | |
|---|---|
| κ | −4.0000E−01 |
| B4 | −3.8887E−02 |
| B6 | −4.9404E−02 |
| B8 | −9.6831E−02 |
| B10 | 2.3289E−01 |
| B12 | −3.0044E−01 |
| B14 | 1.2196E−02 |

3^{rd} surface

Aspheric surface coefficient

| | |
|---|---|
| κ | −5.1216E+01 |
| B4 | −1.9816E−01 |
| B6 | 1.0532E+00 |
| B8 | −2.5111E+00 |
| B10 | 2.7207E+00 |
| B12 | −1.0774E+00 |
| B14 | 0.0000E+00 |

TABLE 2
Example 1 Lens 2

| | | | | Optical |
|---|---|---|---|---|
| | | di | ni | element |
| i^{th} surface | ri | (790 nm) | (790 nm) | name |
| 0 | | ∞ | | |
| 1 | ∞ | 0.0 | | |
| (Diaphragm | | (φ0.85 mm) | | |
| diameter) | | | | |
| 2 | 1.1255 | 0.80000 | 1.53956 | Objective |
| 2′ | 1.1255 | −0.02467 | | lens |
| 3 | −3.2554 | 0.49 | 1.0 | |
| 4 | ∞ | 1.2 | 1.57718 | Disc |
| 5 | ∞ | | 1.0 | |

* The symbol di represents a displacement from i^{th} surface to (i + 1)^{th} surface.
* di′ represents a displacement from i′^{th} surface to i^{th} surface.

2^{nd} surface (0 mm≦h≦0385 mm)

Aspheric surface coefficient

| | |
|---|---|
| κ | −4.1438E−01 |
| B4 | −1.4074E−03 |
| B6 | −3.4478E−03 |
| B8 | 1.5549E−02 |
| B10 | −2.8690E−02 |

2′^{th} surface (0.85 mm<h)

Aspheric surface coefficient

| | |
|---|---|
| κ | −1.0000E−01 |
| B4 | −1.4074E−03 |
| B6 | −3.4478E−03 |
| B8 | 1.5549E−02 |
| B10 | −2.8690E−02 |

3^{rd} surface

Aspheric surface coefficient

| | |
|---|---|
| κ | −1.0369E+01 |
| B4 | 6.4120E−02 |
| B6 | −2.1953E−02 |
| B8 | −5.5664E−02 |
| B10 | 3.5997E−02 |

### Example 2

Example 2 is used preferably for the aforesaid optical pickup apparatuses PU2. Lens data of the first objective lens section relating to Example 2 are shown in Table 3, and lens data of the second objective lens section are shown in Table 4. FIG. 8(a) is a longitudinal spherical aberration diagram of the first objective lens section relating to Example 2, and FIG. 8(b) is a longitudinal spherical aberration diagram of the second objective lens section relating to Example 2, and each longitudinal axis is normalized by an effective diameter.

TABLE 3
Example 2 Lens 1

| | | | | Optical |
|---|---|---|---|---|
| | | di | ni | element |
| i^{th} surface | ri | (408 nm) | (408 nm) | name |
| 0 | | ∞ | | |
| 1 | ∞ | 0.0 | | |
| (Diaphragm | | (φ3.0 mm) | | |
| diameter) | | | | |
| 2 | 1.1228 | 2.10000 | 1.558295 | Objective |
| 2′ | 1.1228 | 0.20227 | | lens |
| 3 | −2.6524 | 0.53 | 1.0 | |
| 4 | ∞ | 0.0875 | 1.618294 | Disc |
| 5 | ∞ | | 1.0 | |

* The symbol di represents a displacement from i^{th} surface to (i + 1)^{th} surface.
* di′ represents a displacement from i′^{th} surface to i^{th} surface.

2^{nd} surface (0 mm≦h≦1.5 mm)

Aspheric surface coefficient

| | |
|---|---|
| κ | −6.8677E−01 |
| B4 | 1.7461E−02 |
| B6 | 4.9610E−03 |
| B8 | 5.8071E−03 |
| B10 | −7.5613E−03 |
| B12 | 3.8811E−03 |
| B14 | 3.3855E−03 |
| B16 | −4.7719E−03 |
| B18 | 2.1120E−03 |
| B20 | −3.3357E−04 |

2′^{th} surface (1.5 mm<h)

Aspheric surface coefficient

| | |
|---|---|
| κ | −1.0000E+00 |
| B4 | 1.7461E−02 |
| B6 | 4.9610E−03 |
| B8 | 5.8071E−03 |
| B10 | −7.5613E−03 |
| B12 | 3.8811E−03 |
| B14 | 3.3855E−03 |
| B16 | −4.7719E−03 |
| B18 | 2.1120E−03 |
| B20 | −3.3357E−04 |

3^{rd} surface

Aspheric surface coefficient

| | |
|---|---|
| κ | −5.1127E+01 |
| B4 | 1.5279E−01 |
| B6 | −2.3651E−01 |
| B8 | 2.9636E−01 |
| B10 | −2.8634E−01 |
| B12 | 1.7810E−01 |
| B14 | −6.1624E−02 |
| B16 | 8.9297E−03 |

TABLE 4
Example 2 Lens 2

| | | | | | | | | Optical |
|---|---|---|---|---|---|---|---|---|
| | | di | ni | di | ni | di | ni | element |
| i^{th} surface | ri | (408 nm) | (408 nm) | (660 nm) | (660 nm) | (784 nm) | (784 nm) | name |
| 0 | | −49 | | −57.38 | | 78.47 | | |
| 1 | ∞ | 0.0 | | 0.0 | | 0.0 | | |
| (Diaphragm | | (φ2.862 | | (φ3.0086 | | (φ2.516 | | |
| diameter) | | mm) | | mm) | | mm) | | |
| 2 | 1.5132 | 1.37000 | 1.558295 | 1.37000 | 1.539203 | 1.37000 | 1.535907 | Objective |
| 2′ | 1.5342 | 0.00050 | | 0.00050 | | 0.00050 | | lens |
| 2″ | 1.5342 | −0.19671 | | −0.19671 | | −0.19671 | | |
| 3 | −10.5245 | 1.02 | 1.0 | 1.11 | 1.0 | 0.89 | 1.0 | |
| 4 | ∞ | 0.6 | 1.618294 | 0.6 | 1.57718 | 1.2 | 1.570672 | Disc |
| 5 | ∞ | | 1.0 | | 1.0 | | 1.0 | |

* The symbol di represents a displacement from i^{th} surface to (i + 1)^{th} surface.
* Each of di′ and di″ represents a displacement from each of i′^{th} and i″^{th} surface to i^{th} surface.

Diffraction order

| i^{th} surface | 408 nm | 660 nm | 784 nm |
|---|---|---|---|
| 2 | 2 | 1 | 1 |
| 2′ | 0 | 3 | |

2^{nd} surface (0 mm≦h≦1.40952 mm)

| | |
|---|---|
| | Optical path difference |
| Aspheric surface | function coefficient |
| coefficient | (blaze wavelength 1 mm) |

| | | | |
|---|---|---|---|
| κ | −5.2440E−01 | C2 | −3.0079E+06 |
| B4 | 3.1278E−03 | c4 | −3.1217E+05 |
| B6 | 3.0595E−03 | C6 | 3.1158E+05 |
| B8 | 5.7433E−04 | C8 | −2.1006E+05 |
| B10 | −1.6889E−03 | C10 | 4.5632E+04 |
| B12 | 9.8200E−04 | | |
| B14 | −2.3092E−04 | | |

2′^{th} surface (1.40952 mm<h≦1.482 mm)

| | |
|---|---|
| | Optical path difference |
| Aspheric surface | function coefficient |
| coefficient | (blaze wavelength 1 mm) |

| | | | |
|---|---|---|---|
| κ | −5.0723E−01 | C2 | −3.2156E+06 |
| B4 | 4.4067E−03 | c4 | −1.6184E+05 |
| B6 | 3.3604E−03 | C6 | 2.9589E+05 |
| B8 | 4.7713E−04 | C8 | −1.8955E+05 |
| B10 | −1.6583E−03 | C10 | 4.7894E+04 |
| B12 | 1.0226E−03 | | |
| B14 | −2.3616E−04 | | |

2″^{th} surface (1.482 mm<h)

Aspheric surface coefficient

| | |
|---|---|
| κ | −1.0000E−01 |
| B4 | 4.4067E−03 |
| B6 | 3.3604E−03 |
| B8 | 4.7713E−04 |
| B10 | −1.6583E−03 |
| B12 | 1.0226E−03 |
| B14 | −2.3616E−04 |

3^{rd} surface

Aspheric surface coefficient

| | |
|---|---|
| κ | −2.0751E+01 |
| B4 | 2.6828E−02 |
| B6 | −5.1703E−03 |
| B8 | −4.2399E−03 |
| B10 | 0.001824967 |
| B12 | −0.000264915 |
| B14 | 6.43016E−06 |

### Example 3

Example 3 is used preferably for the aforesaid optical pickup apparatuses PU2. Lens data of the first objective lens section relating to Example 3 are shown in Table 5, and lens data of the second objective lens section are shown in Table 6. FIG. 9(a) is a longitudinal spherical aberration diagram of the first objective lens section relating to Example 3, and FIG. 9(b) is a longitudinal spherical aberration diagram of the second objective lens section relating to Example 3, and each longitudinal axis is normalized by an effective diameter.

TABLE 5
Example 3 Lens 1

| | | | | Optical |
|---|---|---|---|---|
| | | di | ni | element |
| i^{th} surface | ri | (408 nm) | (408 nm) | name |
| 0 | | ∞ | | |
| 1 | ∞ | 0.0 | | |
| (Diaphragm | | (φ3.0 mm) | | |
| diameter) | | | | |
| 2 | 1.1393 | 2.10000 | 1.558295 | Objective |
| 2′ | 1.1600 | 0.02913 | | lens |
| 3 | −2.4744 | 0.55 | 1.0 | |
| 4 | ∞ | 0.0875 | 1.618294 | Disc |
| 5 | ∞ | | 1.0 | |

* The symbol di represents a displacement from i^{th} surface to (i + 1)^{th} surface.
* di′ represents a displacement from i′^{th} surface to i^{th} surface.

2^{nd} surface (0 mm≦h≦1.5 mm)

Aspheric surface coefficient

| | |
|---|---|
| κ | −7.0786E−01 |
| B4 | 1.4956E−02 |
| B6 | 3.4721E−03 |
| B8 | 3.4189E−03 |
| B10 | −7.6407E−03 |
| B12 | 3.8218E−03 |
| B14 | 3.2183E−03 |
| B16 | −4.8402E−03 |
| B18 | 2.0731E−03 |
| B20 | −3.0305E−04 |

2′^{th} surface (1.5 mm<h)

Aspheric surface coefficient

| | |
|---|---|
| κ | −7.0796E−01 |
| B4 | 1.4956E−02 |
| B6 | 3.4721E−03 |
| B8 | 3.4189E−03 |
| B10 | −7.6407E−03 |
| B12 | 3.8218E−03 |
| B14 | 3.2183E−03 |
| B16 | −4.8402E−03 |
| B18 | 2.0731E−03 |
| B20 | −3.0305E−04 |

3^{rd} surface

Aspheric surface coefficient

| | |
|---|---|
| κ | −2.1931E+01 |
| B4 | 1.0407E−01 |
| B6 | −2.2756E−01 |
| B8 | 3.1535E−01 |
| B10 | −2.8630E−01 |
| B12 | 1.7187E−01 |
| B14 | −6.3280E−02 |
| B16 | 1.0615E−02 |

TABLE 6
Example 3 Lens 2

| | | | | | | | | Optical |
|---|---|---|---|---|---|---|---|---|
| | | di | ni | di | ni | di | ni | element |
| i^{th} surface | ri | (408 nm) | (408 nm) | (660 nm) | (660 nm) | (784 nm) | (784 nm) | name |
| 0 | | −49 | | −57.38 | | 78.47 | | |
| 1 | ∞ | 0.0 | | 0.0 | | 0.0 | | |
| (Diaphragm | | (φ2.862 | | (φ3.0086 | | (φ2.516 | | |
| diameter) | | mm) | | mm) | | mm) | | |
| 2 | 1.5132 | 1.37000 | 1.558295 | 1.37000 | 1.539203 | 1.37000 | 1.535907 | Objective |
| 2′ | 1.5342 | 0.00050 | | 0.00050 | | 0.00050 | | lens |
| 2″ | 1.5342 | −0.19671 | | −0.19671 | | −0.19671 | | |
| 3 | −10.5245 | 1.02 | 1.0 | 1.11 | 1.0 | 0.89 | 1.0 | |
| 4 | ∞ | 0.6 | 1.618294 | 0.6 | 1.57718 | 1.2 | 1.570672 | Disc |
| 5 | ∞ | | 1.0 | | 1.0 | | 1.0 | |

* The symbol di represents a displacement from i^{th} surface to (i + 1)^{th} surface.
* Each of di′ and di″ represents a displacement from each of i′^{th} and i″^{th} surface to i^{th} surface.

Diffraction order

| i^{th} surface | 408 nm | 660 nm | 784 nm |
|---|---|---|---|
| 2 | 2 | 1 | 1 |
| 2′ | 0 | 3 | |

2^{nd} surface (0 mm≦h≦1.40952 mm)

| | |
|---|---|
| | Optical path difference |
| Aspheric surface | function coefficient |
| coefficient | (blaze wavelength 1 mm) |

| | | | |
|---|---|---|---|
| κ | −5.2440E−01 | C2 | −3.0079E+06 |
| B4 | 3.1278E−03 | c4 | −3.1217E+05 |
| B6 | 3.0595E−03 | C6 | 3.1158E+05 |
| B8 | 5.7433E−04 | C8 | −2.1006E+05 |
| B10 | −1.6889E−03 | C10 | 4.5632E+04 |
| B12 | 9.8200E−04 | | |
| B14 | −2.3092E−04 | | |

2′^{th} surface (1.40952 mm≦h<1.482 mm)

| | |
|---|---|
| | Optical path difference |
| Aspheric surface | function coefficient |
| coefficient | (blaze wavelength 1 mm) |

| | | | |
|---|---|---|---|
| κ | −5.0723E−01 | C2 | −3.2156E+06 |
| B4 | 4.4067E−03 | c4 | −1.6184E+05 |
| B6 | 3.3604E−03 | C6 | 2.9589E+05 |
| B8 | 4.7713E−04 | C8 | −1.8955E+05 |
| B10 | −1.6583E−03 | C10 | 4.7894E+04 |
| B12 | 1.0226E−03 | | |
| B14 | −2.3616E−04 | | |

2″^{th} surface (1.482 mm<h)

Aspheric surface coefficient

| | |
|---|---|
| κ | −1.0000E−01 |
| B4 | 4.4067E−03 |
| B6 | 3.3604E−03 |
| B8 | 4.7713E−04 |
| B10 | −1.6583E−03 |
| B12 | 1.0226E−03 |
| B14 | −2.3616E−04 |

3^{rd} surface

Aspheric surface coefficient

| | |
|---|---|
| κ | −2.0751E+01 |
| B4 | 2.6828E−02 |
| B6 | −5.1703E−03 |
| B8 | −4.2399E−03 |
| B10 | 0.001824967 |
| B12 | −0.000264915 |
| B14 | 6.43016E−06 |

Values in respective Examples (including values relating to expressions (1)-(3)) are shown collectively in Table 7.

TABLE 7

| | | Example 1 | Example 2 | Example 3 |
|---|---|---|---|---|
| Surface- | Lens 1 Outer side angle | 43.4 | 65.3 | 61.6 |
| normal | θo1 [degree] | | | |
| angle | Lens 1 Inner side angle | 51.3 | 70.6 | 62.5 |
| | θi1 [degree] | | | |
| | θo1 − θi1 [degree] | −7.9 | −5.4 | −0.8 |
| | L1 [mm] | 0.47 | 1.43 | 1.23 |
| | Wavelength [nm] | 660.0 | 408.0 | 408.0 |
| | Focal length f [mm] | 1.31 | 1.77 | 1.77 |
| | Numerical aperture NA | 0.65 | 0.85 | 0.85 |
| | Magnification m | 0.00 | 0.00 | 0.00 |
| | Effective diameter [mm] | 1.70 | 3.00 | 3.00 |
| | Disc thickness [mm] | 0.6 | 0.0875 | 0.0875 |
| Surface- | Lens 2 Outer side angle | 46.2 | 69.8 | 69.8 |
| normal | θo2 [degree] | | | |
| angle | Lens 2 Inner side angle | 41.5 | 54.8 | 54.8 |
| | θi2 [degree] | | | |
| | θo2 − θi2 [degree] | 4.7 | 15.0 | 15.0 |
| | L2 [mm] | 0.35 | 0.86 | 0.86 |
| Disc 1 | Wavelength [nm] | 790.0 | 408.0 | 408.0 |
| | Focal length f [mm] | 1.67 | 2.30 | 2.30 |
| | Numerical aperture NA | 0.51 | 0.65 | 6.65 |
| | Magnification m | 0.00 | 0.04 | 0.04 |
| | Effective diameter [mm] | 1.70 | 2.82 | 2.82 |
| | Disc thickness [mm] | 1.2 | 0.6 | 0.6 |
| Disc 2 | Wavelength [nm] | | 660.0 | 660.0 |
| | Focal length f [mm] | | 2.41 | 2.41 |
| | Numerical aperture NA | | 0.65 | 0.65 |
| | Magnification m | | 0.04 | 0.04 |
| | Effective diameter [mm] | | 3.00 | 3.00 |
| | Disc thickness [mm] | | 0.6 | 0.6 |
| Disc 3 | Wavelength [nm] | | 784.0 | 784.0 |
| | focal length f [mm] | | 2.39 | 2.39 |
| | Numerical aperture NA | | 0.51 | 0.51 |
| | Magnification m | | −0.03 | −0.03 |
| | Effective diameter [mm] | | 2.52 | 2.52 |
| | Disc thickness [mm] | | 1.2 | 1.2 |

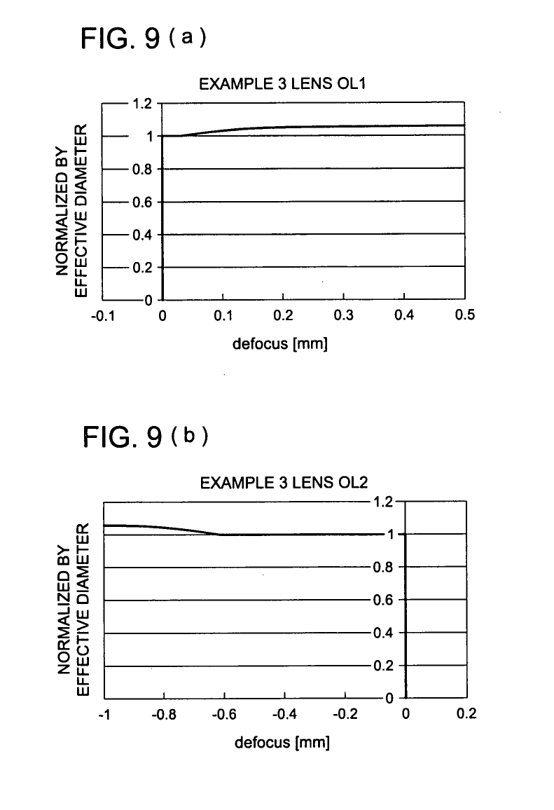

It is preferable, from the viewpoint of improving accuracy for mounting on a bobbin or a mirror cell, that flange section FL has two pairs of confronting sides which are in parallel each other, when optical element OE is viewed in the optical axis direction, as shown in FIG. 10.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An optical element for use in an optical pickup apparatus which comprises a single or a plurality of light source, and an optical element, the optical element comprising:
a first objective lens section and a second objective lens section formed in one body,
wherein the first objective lens section comprises an optical surface divided by a border defined by a first predetermined diameter into
a first inner area arranged on an inside of the border in a direction perpendicular to an optical axis and having a surface-normal angle θi1 at an outer edge thereof, and
a first outer area arranged on an outside of the border in the direction perpendicular to the optical axis and having a surface-normal angle θo1 at an inner edge thereof,
the angle θi1 is larger than the angle θo1,
the second objective lens section comprises an optical surface divided by a border defined by a second predetermined diameter into
a second inner area arranged on an inside of the border in a direction perpendicular to an optical axis and having a surface-normal angle θi2 at an outer edge thereof, and
a second outer area arranged on an outside of the border in the direction perpendicular to the optical axis and having a surface-normal angle θo2 at an inner edge thereof, and
the angle θi2 is smaller than the angle θo2,
wherein the first objective lens section converges a light flux from the light source onto an information recording surface of a first optical information recording medium to record and/or information on the information recording surface of the first optical information recording medium, and to record and/or reproduce information on an information recording surface of a second optical information recording medium by the second objective lens section converges a light flux from the light source onto an information recording surface of a second optical information recording surface of a second optical information recording medium to record and/or information on the information recording surface of the second optical information recording medium, and
wherein the optical element satisfies a following expression,
L1>L2,
where L1 is a distance in a direction of the optical axis from a peak of the optical surface of the first objective lens section to the border defined by the first predetermined diameter, and
L2 is a distance in a direction of the optical axis from a peak of the optical surface of the second objective lens section to the border defined by the second predetermined diameter.

2. The optical element of claim 1,
wherein the border defined by the first predetermined

7. The optical element of claim 1,
the first outer area and the first inner area are continuous.

8. The optical element of claim 1,
the second outer area and the second inner area are continuous.

9. The optical element of claim 1,
wherein at least one of the first outer area and the second outer area comprises a diffractive structure.

10. The optical element of claim 1,
wherein at least one of the first inner area and the second inner area comprises a diffractive structure.

11. The optical element of claim 1,
wherein the first predetermined diameter and the second predetermined diameter have an almost same value.

12. The optical element of claim 1,
wherein the light source comprises a first light source and a second light source,
the first light source emits a light flux with a wavelength λ1, for recording and/or reproducing information on the first optical information recording medium, and
the second light source emits a light flux with a wavelength λ2(λ2>λ1), for recording and/or reproducing information on the second optical information recording medium.

13. An optical element for use in an optical pickup apparatus which comprises a single or a plurality of light source, and an optical element, the optical element comprising:
a first objective lens section and a second objective lens section formed in one body,
wherein the first objective lens section comprises an optical surface divided by a border defined by a first predetermined diameter into
a first inner area arranged on an inside of the border in a direction perpendicular to an optical axis and having a surface-normal angle θi1 at an outer edge thereof, and
a first outer area arranged on an outside of the border in the direction perpendicular to the optical axis and having a surface-normal angle θo1 at an inner edge thereof,
the angle θi1 is larger than the angle θo1,
the second objective lens section comprises an optical surface divided by a border defined by a second predetermined diameter into
a second inner area arranged on an inside of the border in a direction perpendicular to an optical axis and having a surface-normal angle θi2 at an outer edge thereof, and
a second outer area arranged on an outside of the border in the direction perpendicular to the optical axis and having a surface-normal angle θo2 at an inner edge thereof, and
the angle θi2 is smaller than the angle θo2, and
wherein the first objective lens section converges a light flux from the light source onto an information recording surface of a first optical information recording medium comprising a protective substrate whose thickness is t1 to record and/or information on the information recording surface of the first optical information recording medium, and the second objective lens section converges a light flux from the light source onto an information recording surface of a second optical information recording surface of a second optical information recording medium comprising a protective substrate whose thickness is t2 (t1<t2) to record and/or information on the information recording surface of the second optical information recording medium.

14. The optical element of claim 13,
wherein each of the first objective lens section and the second objective lens section consists of a refractive surface.

15. An optical pickup apparatus comprising:
a light source; and
the optical element of claim 13.

16. The optical pickup apparatus of claim 15, further comprising:
a mirror arranged in an optical path between the optical element and the light source,
wherein when the optical pickup apparatus records and/or reproduce information on the first optical information recording medium, the mirror reflects a light flux such that the light flux passes through the first objective lens section,
when the optical pickup apparatus records and/or reproduce information on the second optical information recording medium, the mirror reflects a light flux such that the light flux passes through the second objective lens section, and
a maximum diameter of a light flux at a surface of the mirror when information is recorded and/or reproduced by the first objective lens section has an almost same value to a maximum diameter of a light flux at a surface of the mirror when information is recorded and/or reproduced by the second objective lens section.

17. An optical element for use in an optical pickup apparatus which comprises a single or a plurality of light source, an optical element, and a single or a plurality of objective lens, the optical element comprising:
a first coupling lens section and a second coupling lens section formed in one body,
wherein the first coupling lens section comprises an optical surface divided by a border defined by a first predetermined diameter into
a first inner area arranged on an inside of the border in a direction perpendicular to an optical axis and having a surface-normal angle θi1 at an outer edge thereof, and
a first outer area arranged on an outside of the border in the direction perpendicular to the optical axis and having a surface-normal angle θo1 at an inner edge thereof,
the angle θi1 is larger than the angle θo1,
the second coupling lens section comprises an optical surface divided by a border defined by a second predetermined diameter into
a second inner area arranged on an inside of the border in a direction perpendicular to an optical axis and having a surface-normal angle θi2 at an outer edge thereof, and
a second outer area arranged on an outside of the border in the direction perpendicular to the optical axis and having a surface-normal angle θo2 at an inner edge thereof, and
the angle θi2 is smaller than the angle θo2,
wherein the first coupling lens section makes a light flux from the light source incident to the objective lens so that the objective lens converges the light flux onto an information recording surface of a first optical information recording medium to record and/or information on the information recording surface of the first optical information recording medium, and the second coupling lens section makes a light flux from the light source incident to the objective lens so that the objective lens converges a light flux from the light source onto an information recording surface of a second optical information recording surface of a second optical information recording medium to record and/or information on the information recording surface of the second optical information recording medium, and
wherein the optical element satisfies a following expression,
L1>L2,
where L1 is a distance in a direction of the optical axis from a peak of the optical surface of the first coupling lens section to the border defined by a first predetermined diameter, and
L2 is a distance in a direction of the optical axis from a peak of the optical surface of the second coupling lens section to the border defined by a second predetermined diameter.

18. An optical element for use in an optical pickup apparatus which comprises a single or a plurality of light source, an optical element, and a single or a plurality of objective lens, the optical element comprising:
a first coupling lens section and a second coupling lens section formed in one body,
wherein the first coupling lens section comprises an optical surface divided by a border defined by a first predetermined diameter into
a first inner area arranged on an inside of the border in a direction perpendicular to an optical axis and having a surface-normal angle θi1 at an outer edge thereof, and
a first outer area arranged on an outside of the border in the direction perpendicular to the optical axis and having a surface-normal angle θo1 at an inner edge thereof,
the angle θi1 is larger than the angle θo1,
the second coupling lens section comprises an optical surface divided by a border defined by a second predetermined diameter into
a second inner area arranged on an inside of the border in a direction perpendicular to an optical axis and having a surface-normal angle θi2 at an outer edge thereof, and
a second outer area arranged on an outside of the border in the direction perpendicular to the optical axis and having a surface-normal angle θo2 at an inner edge thereof, and
the angle θi2 is smaller than the angle θo2, and
wherein the first coupling lens section makes a light flux from the light source incident to the objective lens so that the objective lens converges the light flux onto an information recording surface of a first optical information recording medium comprising a protective substrate whose thickness is t1 to record and/or information on the information recording surface of the first optical information recording medium, and the second coupling lens section makes a light flux from the light source incident to the objective lens so that the objective lens converges a light flux from the light source onto an information recording surface of a second optical information recording surface of a second optical information recording medium comprising a protective substrate whose thickness is t2 (t1<t2) to record and/or information on the information recording surface of the second optical information recording medium.
